(19) United States
(12) Patent Application Publication
(10) Pub. No.: US 2007/0144117 A1
(43) Pub. Date: Jun. 28, 2007

(54) Cyclone air purifier

(76) Inventors: Chan Jung Park, Suwon-si (KR); Yasuhiko Kochiyama, Seongnam-si (KR); Han Wook Cho, Yongin-si (KR); Sun A. Oh, Seoul (KR)

Correspondence Address: STANZIONE & KIM, LLP, 919 18TH STREET, N.W., SUITE 440, WASHINGTON, DC, 20006, US

(21) Appl. No.: 11/496,506

(22) Filed: Aug. 1, 2006

(30) Foreign Application Priority Data
Dec. 28, 2005 (KR) 2005-132245

(51) Int. Cl. B01D 45/12

(52) U.S. Cl. 55/345

(57) ABSTRACT

A cyclone air purifier reduces pressure loss and noise generated from second cyclones and has an improved dust collecting efficiency. The cyclone air purifier includes a cylindrical main body, at least one first cyclone having at least one inlet formed through a side surface the main body to receive air therethrough and to perform a first dust separation operation on the air introduced therein having a first outlet pipe to discharge a first part of the air, and at least one second cyclone to receive a second part of the air from the first cyclone and to perform a second dust separation operation on the second part of the received air. An ionizer is installed in the first cyclone to ionize the dust in the air, and an inductor is installed in a guide duct, which connects the first and the second cyclones, to induce small particles of the ionized dust in the first cyclone into the second cyclone using an electrically attractive force.

### CROSS-REFERENCE TO RELATED APPLICATIONS

This application claims the benefit of Korean Patent Application No. 2005-0132245, filed Dec. 28, 2005, in the Korean Intellectual Property Office, the disclosure of which is incorporated herein by reference in its entirety.

### BACKGROUND OF THE INVENTION

1. Field of the Invention

The present general inventive concept relates to an air purifier, and more particularly, to an air purifier having cyclones.

2. Description of the Related Art

A cyclone device is a device for collecting solid or liquid fine particles floating in air using the principle that particles in rotating air are separated by centrifugal force and gravity. The cyclone device is used in a vacuum cleaner. Korean Patent Laid-open Publication No. 2005-0026218 describes a conventional cyclone device and a vacuum cleaner having the same.

Since air discharged from a first cyclone is introduced into a second cyclone, the second cyclone generates a considerable amount of pressure loss and noise in the conventional cyclone device.

Further, since an inlet, through which air is introduced into the first cyclone, is formed through a designated portion of a side surface of a main body of the conventional cyclone device, an amount of air introduced into the main body is limited. Accordingly, the conventional cyclone device cannot be applied to an air purifier for simultaneously purifying a large amount of air.

Moreover, the cyclone device includes only one first cyclone, thus having a low dust removing efficiency.

### SUMMARY OF THE INVENTION

The present general inventive concept provides a cyclone air purifier, which reduces a pressure loss and noise generated from cyclones.

The present general inventive concept also provides a cyclone air purifier, which increases an amount of air introduced into a main body so as to improve an air purifying capacity and improves an air purifying efficiency.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a cyclone air purifier including a cylindrical main body, at least one first cyclone having at least one inlet formed through a side surface of the main body to receive air therethrough and to perform a first dust separation operation on the air introduced therein and having a first outlet pipe to discharge a first part of the air, and at least one second cyclone to receive a second part of the air from the at least one first cyclone and to perform a second dust separation operation on the received second part of the air.

The cyclone air purifier may further include a guide duct to guide the second part of the air, on which the first dust separation operation has been performed, to the at least one second cyclone so that a rotating air current is formed.

The cyclone air purifier may further include an ionizer installed in the at least one first cyclone to ionize dust in the air, and an inductor installed in the guide duct to induce small particles of the ionized dust in the at least one first cyclone to be introduced into the at least one second cyclone using an electrically attractive force.

The ionizer may include a plurality of discharge needles installed on an outer surface of the first outlet pipe in a circumferential direction, and a grounded electrode plate installed on an inner surface of the at least one first cyclone opposite to the discharge needles.

The small particles of the dust ionized by the ionizer may be induced into the at least one second cyclone by the inductor, and large particles of the dust ionized by the ionizer may be collected in a dust collector provided under the main body.

The cyclone air purifier may further include a guide formed on the at least one first cyclone to guide the air introduced into the at least one first cyclone through the first inlet to form a rotating air current in the at least one first cyclone.

The cyclone air purifier may further include a second outlet pipe formed longitudinally through the at least one second cyclone to discharge the second part of the air, on which the first and second dust separation operations have been performed, out of the at least one second cyclone.

The cyclone purifier may further include a filter installed on an upper surface of the main body to filter the dust from the first and second parts of the air discharged from the first outlet and the second outlet, respectively.

A plurality of the first cyclones may be disposed in a circumferential direction in the main body along an inner surface thereof, and a plurality of second cyclones may be disposed in a circumferential direction of the first cyclones such that the first cyclones are arranged around the second cyclones.

The foregoing and/or other aspects of the present general inventive concept may also be achieved by providing a cyclone air purifier including a cylindrical main body, at least one first cyclone to receive air through inlets formed through a side surface of the main body and to perform a first dust separation operation on the received air to discharge a first part of the air, at least one second cyclone to receive a second part of the air from the at least one first cyclone and to perform a second dust separation operation on the received first part of the air, an ionizer installed in the at least one first cyclone to ionize dust in the air, a guide duct to connect the first cyclone with the second cyclone, and an inductor installed in the guide duct to induce the dust ionized by the ionizer into the at least one second cyclone.

The at least one first cyclone may include a first outlet pipe formed longitudinally thereon to discharge the first part of the air, on which the first dust separation operation has been performed, out of the at least one first cyclone, and the at least one second cyclone may include a second outlet pipe formed thereon to discharge the second part of the air, on which the first and second dust separation operations are performed, out of the at least one second cyclone.

The ionizer may include a plurality of discharge needles installed on an outer surface of the first outlet pipe in a circumferential direction, and a grounded electrode plate installed on an inner surface of the at least one first cyclone opposite to the discharge needles.

The cyclone air purifier may further include a filter installed on an upper surface of the main body to filter the dust from the first and second parts of the air discharged from the first outlet and the second outlet, respectively.

The foregoing and/or other aspects of the present general inventive concept may also be achieved by providing an air purifier including a main body to receive air, a first cyclone disposed in the main body to purify a first portion of the received air, and a second cyclone disposed in the main body and having a guide duct to receive a second portion of the received air from the first cyclone to purify the second portion of the received air.

### BRIEF DESCRIPTION OF THE DRAWINGS

These and/or other aspects of the general inventive concept will become apparent and more readily appreciated from the following description of the embodiments, taken in conjunction with the accompanying drawings in which:

FIG. 1 is an exploded perspective view of a cyclone air purifier in accordance with an embodiment of the present general inventive concept;

FIG. 2 is a plan view of a main body of the cyclone air purifier of FIG. 1, in accordance with an embodiment of the present general inventive concept; and

FIG. 3 is an exploded perspective view illustrating first and second cyclones of the main body of the cyclone air purifier of FIG. 1.

### DETAILED DESCRIPTION OF THE PREFERRED EMBODIMENTS

Reference will now be made in detail to the embodiment of the present general inventive concept, an example of which is illustrated in the accompanying drawings, wherein like reference numerals refer to like elements throughout. The embodiment is described below to explain the present general inventive concept by referring to the annexed drawings.

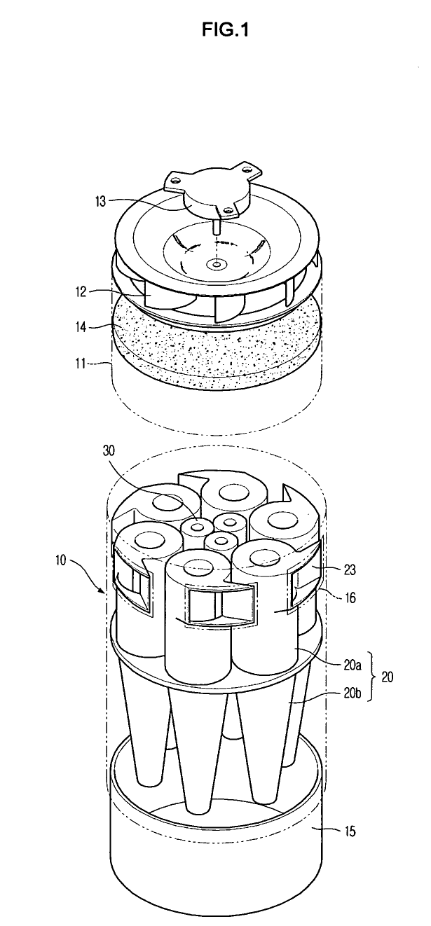

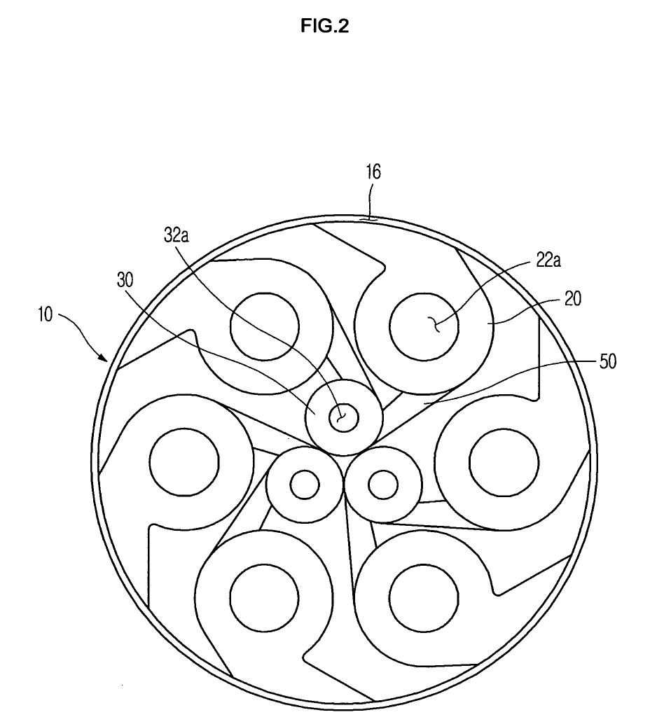

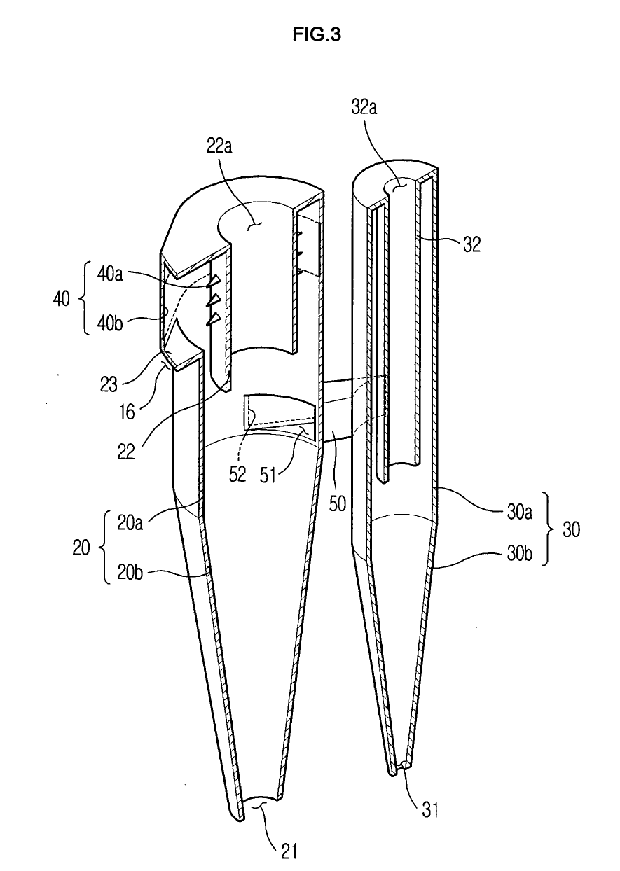

FIG. 1 is an exploded perspective view of a cyclone air purifier in accordance with an embodiment of the present general inventive concept. FIG. 2 is a plan view of a main body 10 of the cyclone air purifier of FIG. 1, in accordance with an embodiment of the present general inventive concept. FIG. 3 is an exploded perspective view illustrating first and second cyclones 20 and 30 of the main body 10 of the cyclone air purifier of FIG. 1. As illustrated in FIG. 1, the cyclone air purifier includes the main body 10, in which a plurality of the first cyclones 20 and a plurality of the second cyclones 30 are formed. The detailed structure of the main body 10 will be described later.

As illustrated in FIG. 1, a discharge guide tub 11 is installed on an upper surface of the main body 10 to guide purified air to be discharged out of the cyclone air purifier. A lower surface of the discharge guide tub 11 is opened, and the opened lower surface of the discharge guide tub 11 is connected to the main body 10. An air blast fan 12 is installed in an upper portion of the discharge guide tub 10 to discharge the purified air, and a fan motor 13 installed on the air blast fan 12 to drive the air blast fan 12. The discharge guide tub 11 is fixed to the upper surface of the main body 10. A filter 14 to filter out fine dust particles, which are removed using the first cyclones 20 and the second cyclones 30, is detachably installed in the discharge guide tub 11.

A dust collector 15 having an opened upper surface is installed on a lower surface of the main body 10 to collect dust. The dust collector 15 is separated from the first cyclones 20 and the second cyclones 30, and is detachably installed on the main body 10 so that the dust collector 15 can be detached from the main body 10 to be cleaned.

A plurality of the first cyclones 20 are installed inside the main body 10 to separate relatively large dust particles from air, which is sucked into the main body 10, and a plurality of the second cyclones 30 are also installed inside the main body 10 to separate relatively small dust particles from the air. The first cyclones 20 are disposed in a circumferential direction in the main body 10 such that the first cyclones 20 are arranged around the second cyclones 30, and the second cyclones 30 are disposed in a circumferential direction of the first cyclones 20 along inner surfaces thereof. The circumferential arrangement of the first and second cyclones 20 and 30 in the main body 10 enables a number of the first and second cyclones 20 and 30 in the main body 10 to be maximized, thereby increasing an air purifying capacity and a dust removing efficiency of the cyclone air purifier.

A plurality of first inlets 16, through which air is introduced into the first cyclones 20, are formed through a side surface of the main body 10. The first inlets 16 are disposed on the side surface of the main body 10 in the circumferential direction and are positioned to correspond to positions of the first cyclones 20 within the main body 10 so that air is introduced to the first cyclones 20.

Referring to FIG. 2, air is introduced into the first cyclones 20 through the first inlets 16 formed through the side surface of the main body 10, and the air is rotated in the first cyclones 20 so that large dust particles are removed from the air. Thereafter, a part of the air (i.e., a first part of the air) is discharged out of the first cyclones 20 upward through first outlets 22a, and a remainder of the air (i.e., a second part of the air) is introduced into the second cyclones 30 through guide ducts 50. The air (i.e., the second part of the air), which is introduced into the second cyclones 30, is rotated in the second cyclones 30 so that small dust particles are removed from the air. The air rotated in the second cyclones 30 is then discharged upward through second outlets 32a. The first cyclone 20 and the second cyclone 30 may include a plurality of first sub-cyclones 20 and a plurality of second sub-cyclones 30, respectively.

Referring to FIG. 3, each of the first cyclones 20 includes a cylindrical portion 20a having a uniform diameter and a conical portion 20b extending from a lower portion of the cylindrical portion 20a and having a diameter that decreases from an upper portion thereof to a lower portion thereof. A first guide hole 21 to guide the large dust particles, which are separated from the air by centrifugal force induced by rotation of the air, to the dust collector 15 is formed through the lower portion of the conical portion 20b. A first outlet pipe 22 to form the first outlet 22a to discharge the first part of the air, from which the large dust particles are separated, is installed at an approximate center of the cylindrical portion 20a.

A guide 23 is formed in each of the first cyclones 20 to guide the air introduced to the first cyclone 20 through the first inlet 16 of the main body 10 to the cylindrical portion 20a of the first cyclone 20 so as to form a rotating air current in the first cyclone 20.

An ionizer 40 is installed in the cylindrical portion 20a of each of the first cyclones 20 to ionize dust in the air introduced into the first cyclone 20 by the guide 23. The ionizer 40 includes discharge needles 40a, which are separated from each other, and a grounded electrode plate 40b.

A plurality of the discharge needles 40a are disposed on an outer circumferential surface of the first outlet pipe 22 around a circumferential direction, and the grounded electrode plate 40b is disposed in an inner surface of the cylindrical portion 20a. When a positive (+) voltage is applied to the discharge needles 40a of the ionizer 40, a corona discharge is generated, and thus the dust in the air introduced into the cylindrical portion 20a of the first cyclone 20 through the first inlet 16 is ionized and has a positive (+) charge.

In the same manner as the first cyclones 20, each of the second cyclones 30 includes a cylindrical portion 30a provided at an upper portion thereof and a conical portion 30b provided at a lower portion thereof. A second guide hole 31 is formed through the lower portion of the conical portion 30b to guide the small dust particles separated from the air (i.e., the second part of the air) to the dust collector 15. A guide duct 50 connects the cylindrical portion 20a of the first cyclone 20 to the second cyclone 30 to guide the second part of the rotating air in the corresponding first cyclone 20 to the second cyclone 30. The guide duct 50 is installed at a side surface of the cylindrical portion 30a, and a second outlet pipe 32 that forms the second outlet 32a to discharge the air (i.e., the second part of the air), from which the small dust particles are separated, is installed at an approximate center of the cylindrical portion 30a.

A second inlet 51 is provided in the guide duct 50 to connect the cylindrical portion 30a of the second cyclone 30 to guide the air introduced to the second cyclone 30 to be rotated.

An inductor 52 is installed in the guide duct 50 to induce the dust, which is ionized to have the positive (+) charge in the cylindrical portion 20a of the first cyclone 20, to be introduced into the second inlet 51. The inductor 52 has a negative (−) charge, and thus electrically attracts the dust particles ionized to have the positive (+) charge so that small dust particles are introduced into the second inlet 51.

Hereinafter, the operation of the cyclone air purifier of the present embodiment will be described with reference to FIGS. 1 to 3.

When the cyclone air purifier starts to operate, the fan motor 13 is driven and the air blast fan 12 is rotated. Air around the cyclone air purifier is sucked into the main body 10 through the first inlets 16 formed through the side surface of the main body 10 by the suction force of the air blast fan 12. The air around the cyclone air purifier is drawn in through the first inlets 16 when the air blast fan 12 draws air from the first and second cyclones 20 and 30, respectively, thereby creating a negative pressure in the cylindrical portions 20a and 30a.

The air, which is sucked into the main body 10 through the first inlets 16, is guided to the cylindrical portions 20a of the first cyclones 20 by the guides 23, thus forming rotating air currents. Dust contained in the rotating air in the cylindrical portions 20a of the first cyclones 20 is ionized by the ionizers 40, thus having a positive (+) charge. The rotating air in spaces between the inner surfaces of the cylindrical portions 20a of the first cyclones 20 and the outer surfaces of the first outlet pipes 22 gradually descends by the centrifugal force. The air descends to an opening portion of the first outlet pipe 22 due to the negative pressure in the first cyclone 20 created by the air blast fan 12. Large dust particles contained in the descending air are discharged out of the first cyclones 20 through the first guide holes 21 by gravity and are collected in the dust collector 15, and small dust particles contained in the descending air and a part of the air (i.e., the second part of the air) are introduced into the second inlets 51 formed in the guide ducts 50 by the electrically attractive force of the inductors 52.

Since most of the small dust particles are introduced into the second cyclones 30 using the ionizers 40 and the inductors 52, as described above, it is possible to improve a dust separating efficiency of the cyclone air purifier.

Further, a part of the air rotating in the first cyclones 20 (i.e., the first part of the air), from which dust particles are separated, is not introduced into the second cyclones 30, but is instead discharged out of the first cyclones 20 through the first outlets 22a. Accordingly, it is possible to reduce a pressure loss and noise generated when a large amount of air is simultaneously introduced into the second cyclones 30.

The air (i.e., the second part of the air), which is introduced into the cylindrical portions 30a of the second cyclones 30 through the second inlets 51, forms rotating air currents in the second cyclones 30 and gradually descends. Then, the small dust particles in the second cyclones 30 are collected in the dust collector 15, and the air, from which the dust particles are separated, is discharged out of the second cyclones 30 through the second outlets 32a.

The air discharged out of the first and second cyclones 20 and 30 through the first outlets 22a and the second outlets 32a is finally filtered by the filter 14, and is then discharged out of the cyclone air purifier.

As described above, the various embodiments of the present general inventive concept provide a cyclone air purifier, in which a part of air rotating in one or more first cyclones, from which dust particles are partially separated, is not introduced into one or more second cyclones, but is instead discharged out of the first cyclones through one or more first outlets, thereby reducing a pressure loss and noise generated by the second cyclones.

A cyclone air purifier according to the embodiments of the present general inventive concept has a plurality of first inlets to draw air into a main body, thus having an improved air purifying capacity.

A cyclone air purifier according to the embodiments of the present general inventive concept also allows most small dust particles to be introduced into the second cyclones using ionizers and inductors, thus having an improved air purifying efficiency.

Although an embodiment of the general inventive concept has been shown and described, it should be appreciated by those skilled in the art that changes may be made in these embodiments without departing from the principles and spirit of the general inventive concept, the scope of which is defined in the claims and their equivalents.

What is claimed is:

1. A cyclone air purifier comprising:
a cylindrical main body;
at least one first cyclone having at least one inlet formed through a side surface of the main body to receive air therethrough and to perform a first dust separation operation on the air introduced therein and having a first outlet pipe to discharge a first part of the air; and
at least one second cyclone to receive a second part of the air from the at least one first cyclone and to perform a second dust separation operation on the received second part of the air.

2. The cyclone air purifier as set forth in claim 1, further comprising:
a guide duct to guide the second part of the air, on which the first dust separation operation has been performed, to the at least one second cyclone so that a rotating air current is formed.

3. The cyclone air purifier as set forth in claim 2, further comprising:
an ionizer installed in the at least one first cyclone to ionize dust in the air; and
an inductor installed in the guide duct to induce small particles of the ionized dust in the at least one first cyclone into the at least one second cyclone using an electrically attractive force.

4. The cyclone air purifier as set forth in claim 3, wherein the ionizer comprises:
a plurality of discharge needles installed on an outer surface of the first outlet pipe in a circumferential direction; and
a grounded electrode plate installed on an inner surface of the at least one first cyclone opposite to the discharge needles.

5. The cyclone air purifier as set forth in claim 3, wherein the small particles of the dust ionized by the ionizer are induced into the at least one second cyclone by the inductor, and large particles of the dust ionized by the ionizer are collected in a dust collector provided under the main body.

6. The cyclone air purifier as set forth in claim 1, further comprising:
a guide formed on the at least one first cyclone to guide the air introduced into the at least one first cyclone through the at least one first inlet to form a rotating air current in the at least one first cyclone.

7. The cyclone air purifier as set forth in claim 1, further comprising:
a second outlet pipe formed longitudinally through the at least one second cyclone to discharge the second part of the air, on which the first and second dust separation operations are performed, out of the at least one second cyclone.

8. The cyclone air purifier as set forth in claim 7, further comprising:
a filter installed on an upper surface of the main body to filter the dust from the first and second parts of the air discharged from the first outlet and the second outlet, respectively.

9. The cyclone air purifier as set forth in claim 1, wherein a plurality of the first cyclones are disposed in a circumferential direction in the main body along an inner surface thereof, and a plurality of the second cyclones are disposed in a circumferential direction of the first cyclones such that the first cyclones are arranged around the second cyclones.

10. A cyclone air purifier comprising:
a cylindrical main body;
at least one first cyclone to receive air through inlets formed through a side surface of the main body and to perform a first dust separation operation on the received air to discharge a first part of the air;
at least one second cyclone to receive a second part of the air from the at least one first cyclone and to perform a second dust separation operation on the received first part of the air;
an ionizer installed in the at least one first cyclone to ionize dust in the air;
a guide duct to connect the at least one first cyclone and the at least one second cyclone; and
an inductor installed in the guide duct to induce the dust ionized by the ionizer into the at least one second cyclone.

11. The cyclone air purifier as set forth in claim 10, wherein:
the at least one first cyclone comprises a first outlet pipe formed thereon to discharge the first part of the air, on which the first dust separation operation is performed, out of the at least one first cyclone; and
the at least one second cyclone comprises a second outlet pipe formed thereon to discharge the second part of the air, on which the first and second dust separation operations are performed, out of the at least one second cyclone.

12. The cyclone air purifier as set forth in claim 11, wherein the ionizer comprises:
a plurality of discharge needles installed on an outer surface of the first outlet pipe in a circumferential direction; and
a grounded electrode plate installed on an inner surface of the at least one first cyclone opposite to the discharge needles.

13. The cyclone air purifier as set forth in claim 11, further comprising:
a filter installed on an upper surface of the main body to filter out dust from the first and second parts of the air discharged from the first outlet and the second outlet, respectively.

14. An air purifier comprising:
a main body to receive air;
a first cyclone disposed in the main body to purify a first portion of the received air and having a first outlet to output the purified first portion of the air; and
a second cyclone disposed in the main body and having a guide duct to receive a second portion of the received air from the first cyclone to purify the second portion of the received air and having a second outlet to output the purified second portion of the air.

15. The air purifier as set forth in claim 14, wherein:
the first cyclone comprises a plurality of first sub-cyclones; and
the guide duct comprises a plurality of guide ducts to connect corresponding ones of the plurality of the first sub-cyclones to the second cyclone.

16. The air purifier as set forth in claim 14, wherein:
the first cyclone comprises a first number of first sub-cyclones; and
the second cyclone comprises a second number of second sub-cyclones, and the first number of first sub-cyclones is greater than the second number of second sub-cyclones.

17. The air purifier as set forth in claim 16, wherein the guide duct comprises a plurality of ducts each to guide two or more of the first sub-cyclones to one of the second sub-cyclones.

18. The air purifier as set forth in claim 14, wherein the first cyclone comprises a first inlet to receive the air, and the duct is connected between the first cyclone and the second cyclone as a second inlet of the second cyclone to receive the second portion of the received air.

19. The air purifier as set forth in claim 18, wherein the first inlet and the second inlet are not disposed on a same plane.

20. The air purifier as set forth in claim 14, wherein the first outlet and the second outlet are disposed on a same plane.

21. The air purifier as set forth in claim 14, wherein:
the main body comprises a first section and a second section;
the first cyclone comprises a first cylindrical portion disposed in the first section of the main body and a first conical portion disposed in the second section of the main body; and
the second cyclone comprises a second cylindrical portion disposed in the first section of the main body and a second conical portion disposed in the second section of the main body.

22. The air purifier as set forth in claim 21, wherein the first cyclone comprises a first inlet formed on the first cylindrical portion, and the duct is formed to connect to the first cylindrical portion and the second cylindrical portion as a second inlet of the second cylindrical portion.

23. The air purifier as set forth in claim 22, wherein the first inlet and the second inlet are formed on different portions of the first cylindrical portion.

24. The air purifier as set forth in claim 21, further comprising:
a dust collector disposed in the second section of the main body to receive particles from the first conical portion of the first cyclone and second conical portion of the second cyclone.

25. The air purifier as set forth in claim 14, further comprising:
a filter to filter the first and second portions of the air output from the first and second cyclones; and
a fan to discharge the filtered first and second portions of the air outside of the main body.

26. The air purifier as set forth in claim 14, wherein:
the main body comprises an outside section and an inside section disposed inside the outside section;
the first cyclone comprises a plurality of first sub-cyclones disposed in the outside section of the main body; and
the second cyclone comprises a plurality of second sub-cyclones disposed in the inside section of the main body.

27. The air purifier as set forth in claim 14, wherein the duct is disposed in a tangential direction at the first cyclone and the second cyclone.

28. The air purifier as set forth in claim 14, wherein the first cyclone has a first size larger than a second size of the second cyclone.

29. The air purifier as set forth in claim 14, wherein the first cyclone and the second cyclone have a same length.
